(19) United States
(12) Patent Application Publication
(10) Pub. No.: US 2005/0176310 A1
(43) Pub. Date: Aug. 11, 2005

(54) Connection structure of rigid printed circuit board and flexible circuit, the connection process and the circuit module using it

(76) Inventors: Kouichi Kataoka, Yokohama (JP); Katsuya Ohno, Fujisawa (JP); Shinichi Okayama, Fujosawa (JP); Nobuyuki Ura, Yokohama (JP); Fumitoshi Goto, Fujisawa (JP); Yutaka Kakami, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/028,220

(22) Filed: Jan. 4, 2005

(30) Foreign Application Priority Data
Jan. 9, 2004 (JP) 2004-003746

(51) Int. Cl. H01R 4/02

(52) U.S. Cl. 439/876

(57) ABSTRACT

In a connection structure of a rigid printed circuit board and a flexible circuit each having a plurality of connection terminals, there are provided a connection structure that can obtain a necessary connection strength and prevent short-circuiting between adjacent connection terminals, and a connection process thereof. A rigid printed circuit board having a plurality of connection terminals is superimposed on a flexible circuit that puts a conductive pattern having connection terminals having the same configuration as that of the connection terminals of the rigid printed circuit board at an end thereof by flexible insulating resin, and connected to the flexible circuit with a solder due to thermo compression. A solder resist is disposed on the flexible insulating resin on the flexible circuit, and the solder connection can be realized by using a solder plating formed on one or both electrodes of the rigid printed circuit board and the flexible circuit while an amount of occlusion gas is controlled.

### CLAIM OF PRIORITY

The present application claims priority from Japanese application serial No. 2004-003746, filed on (Jan. 9, 2004), the content of which is hereby incorporated by reference into this application.

### BACKGROUND OF THE INVENTION AND RELATED ART STATEMENT

1. Field of the Invention

The present invention relates to a connection structure of a rigid printed circuit board and a flexible circuit, a connection process, and a circuit module using it, and more particularly to a connection structure of a rigid printed circuit board and a flexible circuit, which is suitable for a connection structure of a rigid printed circuit board and a flexible circuit such as an optical module, a connection process, and a circuit module using it.

2. Description of the Related Art

FIGS. 3A and 3B show a conventional connection structure in which a flexible circuit 2 that puts a conductive pattern by two flexible insulating resin sheets is connected to a rigid printed circuit board 1. FIG. 3A is a plan view showing a connected state, and FIG. 3B is a cross-sectional view of a connecting process taken along a line C-C′ of FIG. 3A.

Connection terminals 3 are formed in the rigid printed circuit board 1 having a conductive pattern which is substantially identical in the width and thickness with connection terminals 4 of the conductive pattern of the flexible circuit 2. The connection terminals 3 are positioned with respect to the connection terminals 4 and then superimposed on the connection terminals 4. Thereafter, thermo compression is applied to the flexible circuit 2 from above by means of a heating and pressurization tool 7, and the respective conductive pattern connection terminals 3 and 4 are soldered together, correspondingly. In the figures, reference numeral 6 denotes a solder fillet that has been protruded at the time of connection.

A solder 5 used for connection may be formed by screen-printing a solder cream on the conductive pattern connection terminal 3 side of the rigid printed circuit board 1 or the conductive pattern connection terminal 4 side of the flexible circuit 2 in advance. Alternatively, solder plating may be conducted on both of the connection terminals 3 and 4 in advance.

The art related to the above techniques is disclosed in, for example, Japanese Laid-Open No. 6-85454 and “A Guide to High Density Flexible Circuit” written by Kenshi Numakura, published by Nikkan Kogyo Shinbun, LTD (issued in Dec. 24, 1998).

### OBJECTS AND SUMMARY OF THE INVENTION

In recent years, a demand is made that an optical module is downsized, high in reliability and low in the costs concurrently. In order to meet the demand, it is essential to make mass production with a connection structure using a flexible circuit of a high-precision fine pitch, and a facile connection process.

As shown in FIGS. 3A and 3B, in the structure where the connection terminals of the flexible circuit that puts the conventional conductive pattern by the flexible insulating resin are connected to the connection terminals of the rigid printed circuit board by solder, there is a method in which solder plating is formed on any one or both of the connection terminals of the rigid printed circuit board 1 and the flexible circuit 2. However, in the case where the thickness of the solder plating is too thin, most of the solder 5 is extruded onto the wiring pattern 3 of the rigid printed circuit board 1 due to the thermo compression from above by the heating and pressurization tool 7, thereby making impossible to obtain a sufficient connection strength to withstand a thermal stress or a mechanical stress.

In addition, in the case where the solder is too thick, not only the sufficient connection strength cannot be obtained, but also the solder 5 is extruded between the adjacent conductive patterns 3 of the rigid printed circuit board 1 with the result that short-circuiting is liable to occur. Therefore, the thickness of the solder plating is exact, thereby causing the costs to increase.

Also, when the amount of occlusion gas in the solder plating is large, the gas is discharged at the time of melting the solder. As a result, there is a risk that short-circuiting occurs between the adjacent conductive patterns, or gas remains in the solder as voids, to thereby deteriorate the connection strength.

There is a method in which the solder cream is screen printed on the connection terminal as means for forming the solder. However, it is necessary to control the thickness of the solder and the solder printed position with high precision, and an increase in the costs which is attributable to the addition of an expensive equipment and a deterioration of throughput which is attributable to the addition of processes cannot be prevented. Also, there may occur problems of the short of the connection strength and the short-circuiting between the adjacent conductive patterns as described above.

Accordingly, the present invention has been made to solve the above problems, and therefore an object of the present invention is to provide a connection structure of an improved rigid printed circuit board and a flexible circuit, a connection process, and a circuit module using it.

In order to solve the above object, according to one aspect of the present invention, there is provided a connection structure of a rigid printed circuit board and a flexible circuit, comprising:
a rigid printed circuit board having a plurality of first connection terminals arranged at given intervals;
a flexible circuit having a plurality of second connection terminals that are connected to the corresponding first connection terminals at an end of a conductive pattern, a main portion of the conductive patterns being put by flexible insulating resin while at least areas required for soldering of one surfaces of the second connection terminals are exposed;
a solder layer that electrically connects the first connection terminals and the second connection terminals; and
an insulated support material having a band shape with a given width for regulating a height of the solder connection, the insulated support material being disposed on an end area of the flexible insulating resin which is adjacent to the second connection terminals on the flexible circuit and faces the rigid printed circuit board.

Preferably, in the above connection structure, when it is assumed that the thickness of the insulated support material is t₁, the thickness of the flexible insulating resin that interposes the conductive pattern of the flexible circuit therebetween which faces the rigid printed circuit board is t₂, and the thickness of the solder that is formed on the first connection terminals or the second connection terminals is t₀, the relationship of those thicknesses satisfies t₁+t₂≧t₀.

Also, in order to obtain the above connection structure, according to another aspect of the present invention, there is provided a connection process of a rigid printed circuit board and a flexible circuit, comprising the steps of:
preparing a rigid printed circuit board having a plurality of first connection terminals arranged at given intervals;
preparing a flexible circuit having a plurality of second connection terminals that are connected to the corresponding first connection terminals at an end of a conductive pattern, a main portion of the conductive patterns being put by flexible insulating resin while at least areas required for soldering of one surfaces of the second connection terminals are exposed;
forming a solder layer on at least one of the first connection terminals and the second connection terminals; and
positioning the first connection terminals and the second connection terminals with respect to each other and thermally compressing the first connection terminals and the second connection terminals together in a heated state at a solder melting temperature or higher,
wherein the step of preparing the flexible circuit comprises a step of forming an insulated support material having a band shape with a given width for regulating a height of the solder connection, on an end area of the flexible insulating resin which is adjacent to the second connection terminals on the flexible circuit and faces the rigid printed circuit board.

In the above connection process of a rigid printed circuit board and a flexible circuit, when it is assumed that the thickness of the insulated support material is t₁, the thickness of the flexible insulating resin that interposes the conductive pattern of the flexible circuit therebetween which faces the rigid printed circuit board is t₂, and the thickness of the solder that is formed on the first connection terminals or the second connection terminals is t₀, the relationship of those thicknesses satisfies t₁+t₂≧t₀.

In order to solve the above object, according to still another aspect of the present invention, there is provided a connection structure of a rigid printed circuit board and a flexible circuit, comprising:
a rigid printed circuit board having a plurality of first connection terminals arranged at given intervals;
a flexible circuit having a plurality of second connection terminals that are connected to the corresponding first connection terminals at an end of a conductive pattern, a main portion of the conductive patterns being put by flexible insulating resin while at least areas required for soldering of one surfaces of the second connection terminals are exposed;
a solder layer that electrically connects the first connection terminals and the second connection terminals; and
an insulated support material for regulating a height of the solder connection, which is disposed between at least the second connection terminals on the flexible circuit that faces the first connection terminal surface of the rigid printed circuit board.

Preferably, in the above connection structure, when it is assumed that the thickness of the insulated support material is t₁, the thickness of the flexible insulating resin that interposes the conductive pattern of the flexible circuit therebetween which faces the rigid printed circuit board is t₂, the thickness of the solder that is formed on the first connection terminals or the second connection terminals is t₀, and the thickness of the first connection terminal is t₃, the relationship of those thicknesses satisfies t₁+t₂+t₃≧t₀.

In order to obtain the above connection structure, according to still another aspect of the present invention, there is provided a connection process of a rigid printed circuit board and a flexible circuit, comprising the steps of:
preparing a rigid printed circuit board having a plurality of first connection terminals arranged at given intervals;
preparing a flexible circuit having a plurality of second connection terminals that are connected to the corresponding first connection terminals at an end of a conductive pattern, a main portion of the conductive patterns being put by flexible insulating resin while at least areas required for soldering of one surfaces of the second connection terminals are exposed;
forming a solder layer on at least one of the first connection terminals and the second connection terminals; and
positioning the first connection terminals and the second connection terminals with respect to each other and thermally compressing the first connection terminals and the second connection terminals together in a heated state at a solder melting temperature or higher,
wherein the step of preparing the flexible circuit comprises a step of forming an insulated support material for regulating a height of the solder connection between the adjacent second connection terminals.

Preferably, in the above connection process, when it is assumed that the thickness of the insulated support material is t₁, the thickness of the flexible insulating resin that interposes the conductive pattern of the flexible circuit therebetween which faces the rigid printed circuit board is t₂, the thickness of the solder that is formed on the first connection terminals or the second connection terminals is t₀, and the thickness of the first connection terminal is t₃, the relationship of those thicknesses satisfies t₁+t₂+t₃≧t₀.

In the step of thermally compressing the connection terminals in the connection process, it is desirable to adjust the pressure of the heating and pressurization tool 7 so as to conduct the thermo compression without crushing the support material. For example, the condition where the pressure is 20 Newton (N) or less when the hardness of the support material (pencil hardness) is 2H is desirable.

Also, it is important to appropriately control the thickness of the solder plating that has been formed on the connection terminals in advance and the amount of occlusion gas in the solder. The connection strength is lowered when the solder is too thin or too thick. Also, when the amount of occlusion gas in the solder plating is large, a gas is discharged at the time of melting the solder. As a result, the adjacent conductive patterns are short-circuited, and the gas remains in the solder as voids, thereby causing the connection strength to be deteriorated.

FIG. 4 shows a relationship between the amount of occlusion gas in the solder plating and the quality of the connection structure (yield rate: indicated by %). Also, FIG. 5 shows a relationship between the thickness of the solder plating (μm) and the amount of occlusion gas in the solder plating (wt %). It is understood from those graphs that the thickness of the solder plating preferable in practical use is 20 to 40 μm, and the amount of occlusion gas is 0.15% or less. When the amount of occlusion gas exceeds 0.15%, the defective soldering rapidly increases.

A solder resist is preferable as the support material, however, other resin such as polyimide resin or epoxy resin may be applied if the resin can withstand a temperature at the time of soldering.

Also, it is possible that the same conductive pattern as that of the connection terminals of the flexible circuit, for example, a sacrifice electrode pattern that is electrically neutral or a so-called dummy electrode is disposed as the ground of the support material, and a solder resist is formed on the above conductive pattern to ensure a desired connection height. In this case, the substantial thickness of the support material that regulates the height of the solder connection is represented by the sum of the thickness of the sacrifice electrode pattern as the ground and the thickness of the support material formed on the sacrifice electrode pattern such as the solder resist.

The conductive pattern including the connection terminals is made of, for example, copper, aluminum or an alloy of those materials, which are used as a known wiring material.

When the present invention is applied to, for example, an optical module using the connection structure of the flexible circuit of the fine pitch, an optical module with a high reliability can be realized. Also, it is needless to say that the connection structure of the flexible circuit and the connection process thereof according to the present invention can be applied to general electronic or electric components that require the connection of the fine pitch other than the optical module.

With the connection structure of the rigid printed circuit board and the flexible circuit according to the present invention, a desired height of the solder connection can be ensured by the support material given onto the flexible insulating resin of the flexible circuit, thereby making it possible to obtain the connection strength with a high reliability. In addition, because the solder that is protruded toward the adjacent connection terminal (conductive pattern terminal) is reduced, the short-circuiting between the adjacent connection terminals can be reduced. When, for example, a solder resist is used at the flexible circuit manufacture side as the support material, no specific manufacturing process is required, thereby making it possible to manufacture the flexible circuit without any load.

Also, even in the case where the soldered portion is small in area and has a fine pitch, the amount of occlusion gas in the solder plating is controlled to reduce the voids in the joint metal between the rigid printed circuit board and the flexible circuit, thereby improving the connection strength. Also, the extension of the solder toward the ends of the adjacent connection terminals which is derived from the gas discharge occurring at the time of melting the solder is reduced, as result of which the short-circuiting can be prevented to improve the yield rate.

Accordingly, in the solder connections of the multiple terminals of the rigid printed circuit board and the flexible circuit with a small space and fine pitches, because it is possible to apply the connection process using, as the joint metal, only the solder plating formed on any one or both of the electrode terminals of the rigid printed circuit board and the flexible circuit, the high-throughput and low-costs production can be performed without any addition of a solder printing step, etc.

Also, since the pressurizing force is so controlled as not to crush the support material to conduct the thermal compression, the height of the solder connection can be ensured, thereby obtain the same advantages as those described above. Accordingly, when the present invention is applied to, for example, the optical module, it is possible to provide an optical module that realizes downsizing, high reliability and low costs.

### BRIEF DESCRIPTION OF THE DRAWINGS

These and other objects, features and advantages of the present invention will become more apparent upon consideration of the following description of the preferred embodiments of the present invention taken in conjunction with the accompanying drawings.

FIG. 1A is a schematic plan view for explaining a main portion of a solder connection structure and a connection process thereof according to a first embodiment of the present invention;

FIG. 1B is a schematic cross-sectional view for explaining the main portion of the solder connection structure and the connection process thereof according to the first embodiment of the present invention;

FIG. 1C is a perspective view showing a flexible circuit according to the first embodiment of the present invention;

FIG. 1D is a perspective view showing another flexible circuit according to an embodiment of the present invention;

FIG. 2A is a schematic plan view for explaining a main portion of a solder connection structure and a connection process thereof according to a second embodiment of the present invention;

FIG. 2B is a schematic cross-sectional view for explaining the main portion of the solder connection structure and the connection process thereof according to the second embodiment of the present invention;

FIG. 2C is a perspective view showing a flexible circuit according to the second embodiment of the present invention;

FIG. 3A is a schematic view for explaining a main portion of a solder connection structure and a connection process thereof in a conventional art, and a plan view showing a connected state;

FIG. 3B is a schematic view for explaining the main portion of the solder connection structure and the connection process thereof in the conventional art, and a cross-sectional view showing a connection process taken along a line C-C′ of FIG. 3A;

FIG. 4 is a characteristic graph for explaining a relationship between the amount of occlusion gas in solder plating and the quality of the connection structure;

FIG. 5 is a characteristic graph for explaining a relationship between the thickness of the solder plating and the amount of occlusion gas in the solder plating; and

FIG. 6 is a plan view showing an optical module according to a third embodiment of the present invention.

### DETAILED DESCRIPTION OF THE PREFERRED EMBODIMENTS

Now, a description will be given in more detail of preferred embodiments of the present invention with reference to the accompanying drawings.

### First Embodiment

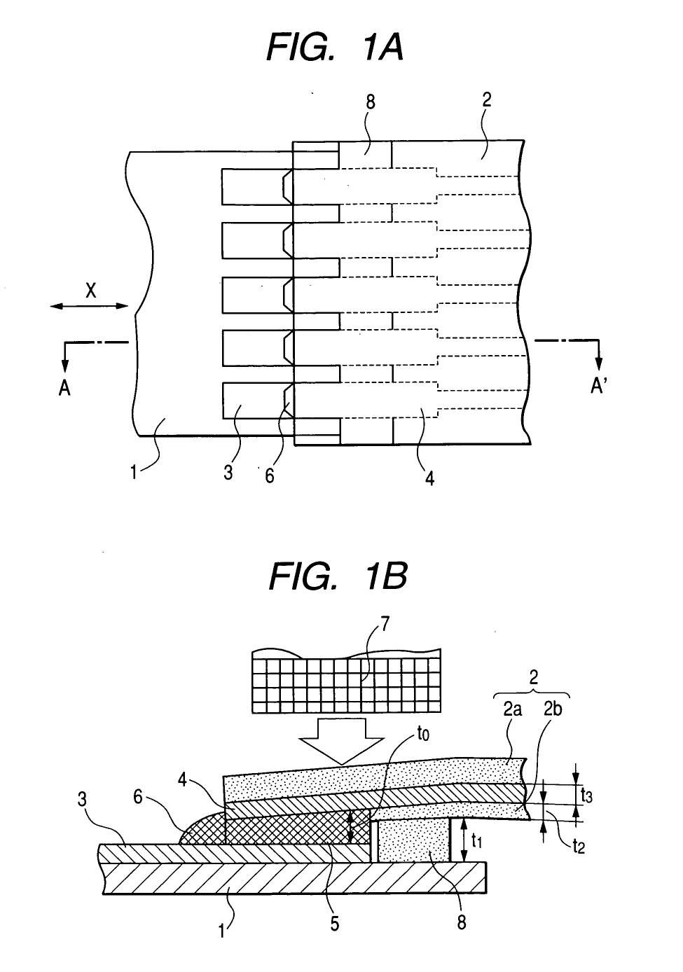

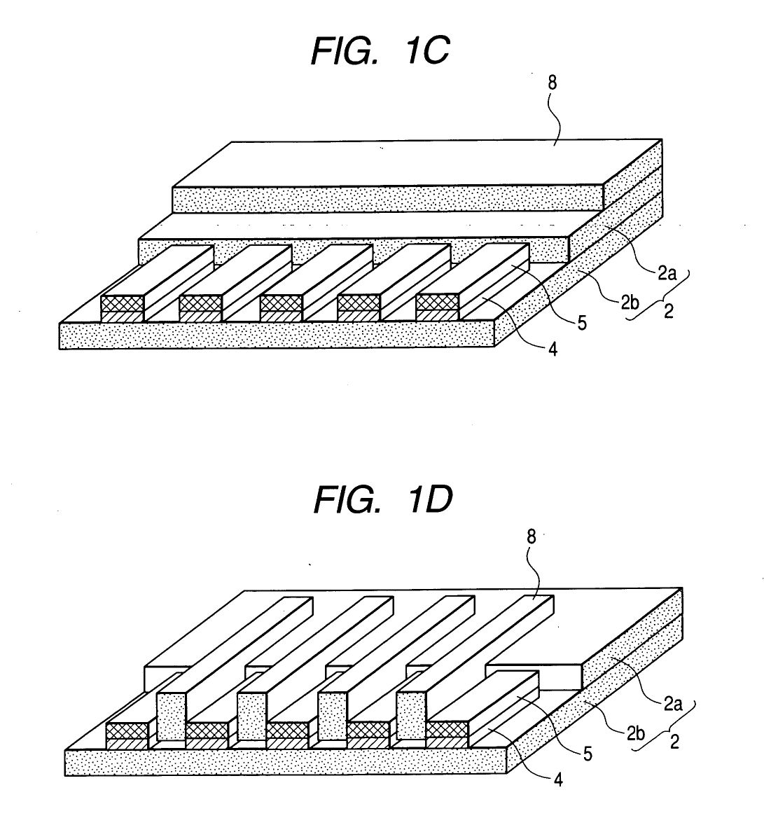

FIG. 1A is a plan view showing an example of a connection structure in which connection terminals 4 of a flexible circuit 2 are connected to connection terminals 3 of a rigid printed circuit board 1 with solder layers 5 according to the present invention. FIG. 1B is a cross-sectional view showing a connection process.

In the figures, reference numeral 1 denotes a rigid printed circuit board that is 0.5 to 2 mm in thickness, and 3 is a plurality of connection terminals (electrodes) corresponding to first connection terminals of the present invention, which are disposed on predetermined portions of the rigid printed circuit board at substantially regular intervals with widths of about 0.2 to 1 mm, lengths of 1.5 to 2 mm and pitches of 0.5 to 1 mm.

In the figures, reference numeral 2 denotes a flexible circuit that puts a conductive pattern by flexible insulating resin that is 20 to 60 μm in thickness. Reference numeral 4 denotes ends of the conductive pattern corresponding to second connection terminals of the present invention. The connection terminals 4 are a conductive pattern made of rolled copper having substantially the same width (about 0.2 to 1 mm), the same pitch and the same thickness 30 to 40 μm as those of the connection terminals 3 disposed on the rigid printed circuit board 1.

One side of the flexible resin is removed in the end area of the flexible circuit on which the connection terminals 4 are disposed, and at least areas of the connection terminals 4 necessary for solder connection, and the connection terminals 4 are connected to the connection terminals 3 of the rigid printed circuit board 1 with the solder layer 5.

The solder layer 5 is a solder resulting from melting and solidifying solder plating that has been formed on the connection terminals 4 of the flexible circuit 2 in advance. Reference numeral 6 denotes a solder fillet, 7 is a heating and pressurization tool, and 8 is a solder resist of about 10 to 20 μm in thickness which forms an insulating support material.

As shown in the perspective view of FIG. 1C, the solder resist 8 is formed on the flexible resin 2b that faces the rigid printed circuit board in the shape of a band so as to be adjacent to the connection terminals 4 of the flexible circuit and slightly apart from the ends of the connection terminals 4.

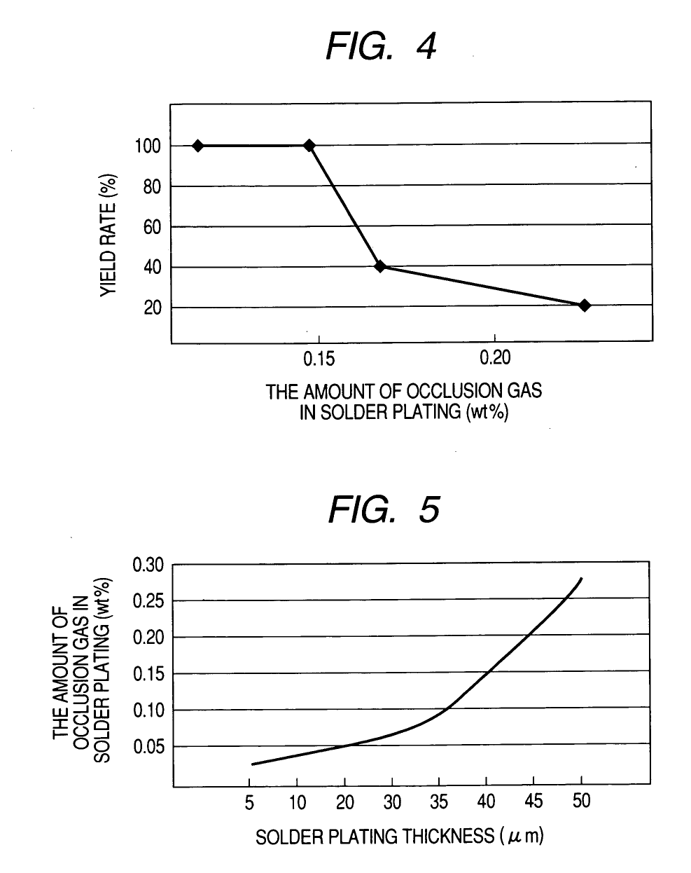

FIG. 4 shows the results of testing the amount of occlusion gas in the solder plating that has been formed on the connection terminals 4 of the flexible circuit 2 in advance and the yield rate of the connection structure after the solder connection has been performed. As is apparent from the figure, when the amount of occlusion gas in the solder plating increases, there occurs a failure such as the separation of the connected portions of the rigid printed circuit board and the flexible circuit, or short-circuiting between the adjacent connection terminals, thereby deteriorating the yield rate. Accordingly, the solder 5 of this embodiment is selected from a solder plating solution which is small in the amount of occlusion gas in the solder plating for coating.

Also, as shown in FIG. 5, when the thickness of the solder plating is thick, the amount of occlusion gas increases. Therefore, the thickness of the solder plating is also appropriately controlled.

Now, a process of manufacturing the connection structure shown in FIGS. 1A and 1B will be described.

First, the solder plating 5 is formed on the connection terminals 4 of the flexible circuit 2 shown in FIG. 1C, and the solder resist 8 is formed on the flexible resin 2b adjacent to the connection terminals 4. The solder resist 8 is formed by disposing a band-like pattern of 1 mm in width on the full width of the circuit 2 in a direction along which the connection terminals 4 are arranged in parallel.

Then, the connection terminals 3 of the rigid printed circuit board 1 and the connection terminals 4 of the flexible circuit 2 are positioned with respect to each other, and then subjected to solder connection. As shown in FIGS. 1A and 1B, the connection terminals 3 of the rigid printed circuit board 1 and the connection terminals 4 of the flexible circuit 2 are superimposed on each other while being preheated. The superimposed width of the connection terminals to be connected in an x-direction is about 0.5 to 1 mm, and spaces between the connection terminals on the respective circuits are about 0.2 mm.

The solder 5 used for connection is a solder plating of 20 to 40 μm in the thickness, which is formed on the connection terminals 4 of the flexible circuit 2 in advance and selected from FIGS. 4 and 5 so that the amount of occlusion gas in the solder plating becomes small. Also, in order to improve the solder leakage, appropriate flux is coated on the solder connection portion.

Then, as shown in FIG. 1B, the heating and pressurization tool 7 that is controlled in the pressurizing force and temperature is pressed against the flexible circuit 2 under the pressurizing force of about 5 to 20 Newton (N) so as not to crush the solder resist 8 that forms the support material. Then, the solder 5 is heated through the flexible circuit 2 by the heating and pressurization tool 7 for several seconds, the solder 5 is melted and solidified, and the respective connection terminals are joined together with the solder at a time.

In this manner, the solder connection is conducted, whereby the height of the solder connection between the opposed connection terminals 3 and 4 can be ensured with the support of the solder resist 8. Also, because the amount of occlusion gas in the solder plating is suppressed, voids in the solder are reduced, thereby obtaining the solder connection with a high reliability, which can sufficiently withstand the thermal stress and the mechanical stress.

Also, the amount of solder extruded between the connection terminals 3 by allowing the solder 5 to be crushed is reduced by the solder resist 8 of the support material, and the amount of occlusion gas in the solder plating is suppressed. As a result, the extension of the solder between the connection terminals 3 due to the gas discharged at the time of melting the solder plating is eliminated. In addition, the solder is appropriately extruded onto the connection terminals 3 of the rigid printed circuit board 1 to form the solder fillet 6. As a result, the short-circuiting between the adjacent connection terminals can be prevented, and the yield rate is improved. The solder fillet 6 thus formed makes it possible to easily visually confirm the quality of the solder connection.

When the connection terminal is plated with the solder, it is important to appropriately control the amount of occlusion gas because the amount of gas occluded in the solder affects the quality of the solder connection. When the amount of occlusion gas exceeds 0.15 wt %, since the defective solder connection occurs, this range should not be exceeded. In the case where the solder plating solution is, for example, boron fluorine bath, it is desirable to conduct plating under the condition where the current density is 2 A/dm² or less. Also, in organic acid bath, it is desirable to conduct plating at 0.5 to 1 A/dm² until about half of a desired thickness, and at about 2 A/dm² for the remaining half, thereby melting and discharging the occlusion gas at an initial heating stage.

The structure shown in FIG. 1A is replaced by the structure shown in FIG. 1D, and the flexible circuit 2 is connected to the rigid printed circuit board 1 in the same manner as that in the above embodiment. Similarly, in this case, there is obtained the connection structure high in the yield and excellent in the quality as in the above embodiment.

The feature of the flexible circuit 2 shown in FIG. 1D resides in that the pattern of the solder resist 8 that forms the support material 8 is disposed between the connection terminals 4. In this case, when it is assumed that the thickness of the support material 8 is t₁, the thickness of the resin that faces the rigid printed circuit board side of the flexible circuit 2 is t₂, the thickness of the connection terminals 3 of the rigid printed circuit board (substantially identical with the thickness of the connection terminals 4) is t₃, and the thickness of the solder is t₀, the relationship of the respective thicknesses satisfies the condition of t₁+t₂+t₃≧tₒ.

As shown in the figure, the pattern of the solder resist 8 that forms the support material 8 may partially cover the resin that faces the rigid printed circuit board side of the flexible circuit 2 at the time of connection, but is formed so as not to cover the connection terminals 4.

### Second Embodiment

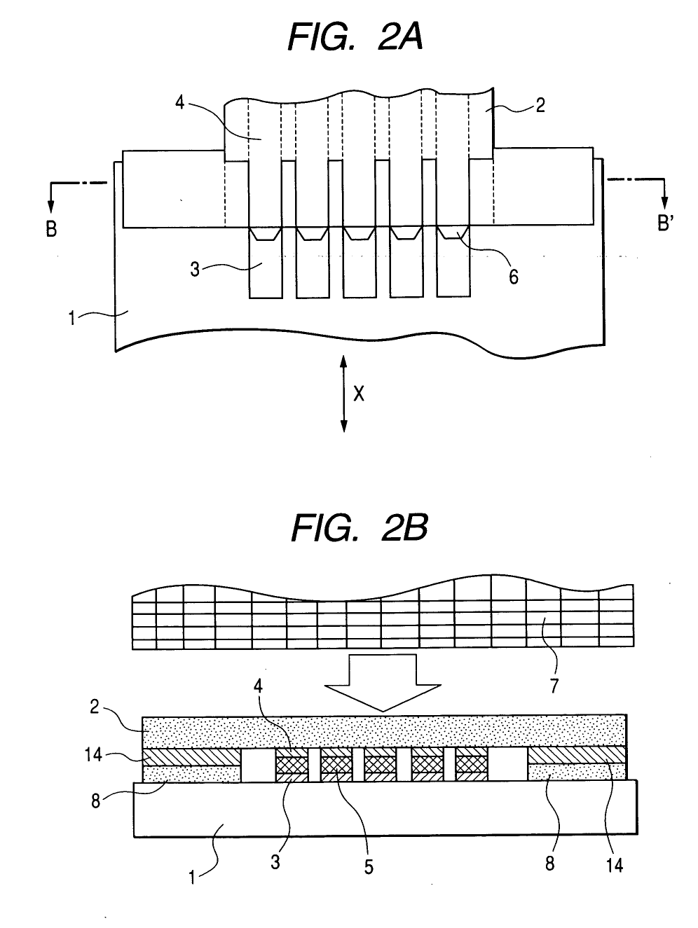

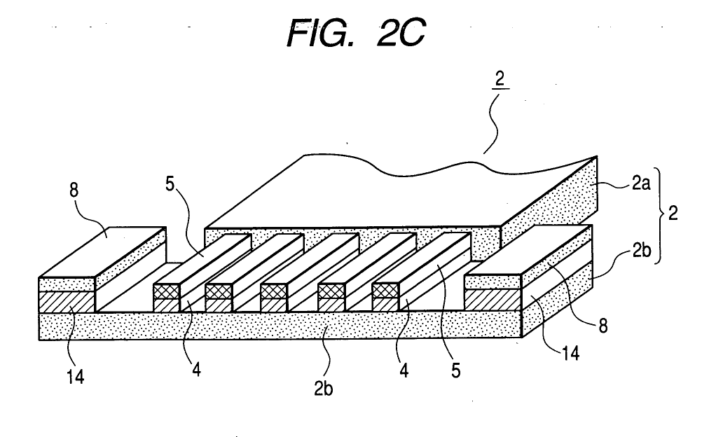

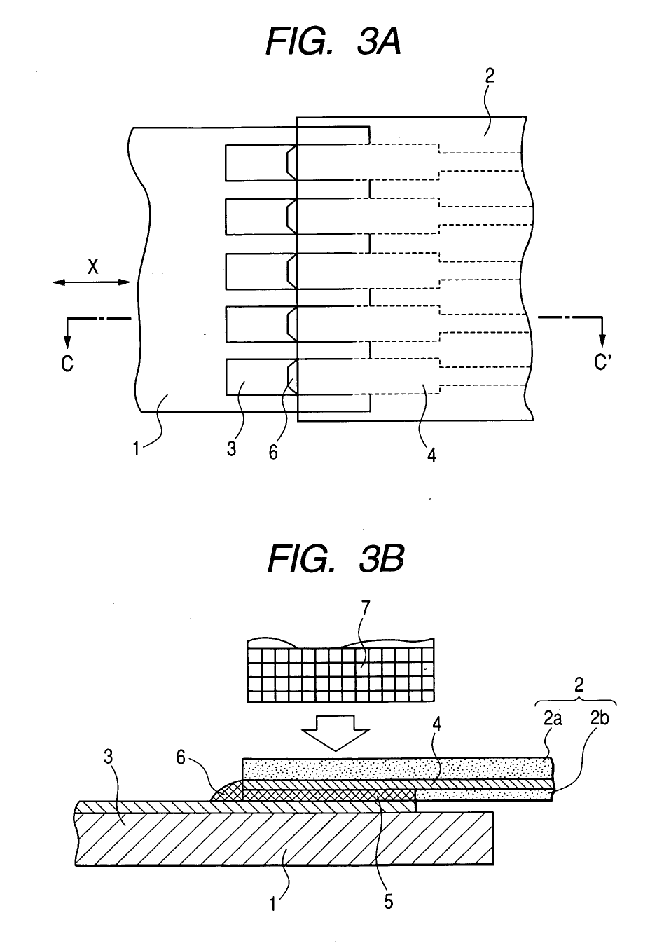

The connection structure of the solder connection portion between the rigid printed circuit board and the flexible circuit, and the connection process thereof according to another embodiment of the present invention will be described with reference to FIGS. 2A to 2C. FIG. 2A shows a plan view, and FIG. 2A shows a cross-sectional view taking along a line B-B′ of FIG. 2A. Fig. 2C shows a perspective view of the flexible circuit 2.

First, the connection process and the connection structure will be described with reference to FIGS. 2A and 2B. In the figures, reference numeral 1 denotes a rigid printed circuit board, 2 is a flexible circuit, 3 is connection terminals of the rigid printed circuit board which is about 0.3 mm in width, and 4 is connection terminals of the flexible circuit, which is about 0.3 mm in width and made of rolled copper excellent in flexibility and electric conductivity. Reference numeral 5 denotes a solder resulting from melting and solidifying the solder plating, which is formed on the connection terminals 4 that form the electrodes of the flexible circuit, 6 is a solder fillet, and 7 is a heating and pressurization tool, 8 is a solder resist of about 20 to 30 μm in thickness. Reference numeral 14 denotes a ground of the solder resist 8 which is formed of the same copper pallet as that of the connection terminals 4, and the sum of the thickness of the solder resist 8 and the ground 14 forms the thickness of the support material that regulates the height of the solder connection.

Hereinafter, the connection process will be described. First, as shown in FIG. 2A, the connection terminals 3 of the rigid printed circuit board 1 and the connection terminals 4 of the flexible circuit 2 are superimposed on each other while being preheated. The superimposed width of the connection terminals 3 and 4 to be connected in an x-direction is about 0.5 to 1 mm and the space between the connection terminals is about 0.2 mm. The solder 5 used for connection in this case is a solder plating of 20 to 40 μm in the thickness, which is formed on the connection terminals 4 of the flexible circuit 2 in advance and selected from FIGS. 4 and 5 so that the amount of occlusion gas in the solder plating becomes small as in the first embodiment. Also, in order to improve the solder leakage, appropriate flux is coated on the solder connection portion.

Then, as shown in FIG. 2B, the heating and pressurization tool 7 that is controlled in the pressurizing force and temperature is pressed against the flexible circuit 2 under the pressurizing force of about 5 to 20 Newton (N) so as not to crush the solder resist 8 that forms the support material. Then, the solder 5 is heated through the flexible circuit 2 by the heating and pressurization tool 7 for several seconds, the solder 5 is melted and solidified, and the respective connection terminals are joined together with the solder at a time. In this manner, the solder connection is conducted, whereby the height of the solder connection can be ensured with the support of the solder resist 8 and the ground 14.

Also, because the amount of occlusion gas in the solder plating is suppressed, voids in the solder are reduced, thereby obtaining the solder connection with a high reliability, which can sufficiently withstand the thermal stress and the mechanical stress.

Also, the amount of solder extruded between the connection terminals 3 by allowing the solder 5 to be crushed is reduced by the solder resist 8 and the ground 14 of the support material, and the amount of occlusion gas in the solder plating is suppressed. As a result, the extension of the solder between the connection terminals 3 due to the gas discharged at the time of melting the solder plating is eliminated. In addition, the solder is appropriately extruded onto the connection terminals 3 of the rigid printed circuit board 1 to form the solder fillet 6. As a result, the short-circuiting between the adjacent connection terminals can be prevented. The solder fillet 6 thus formed makes it possible to easily visually confirm the quality of the solder connection.

### Third Embodiment

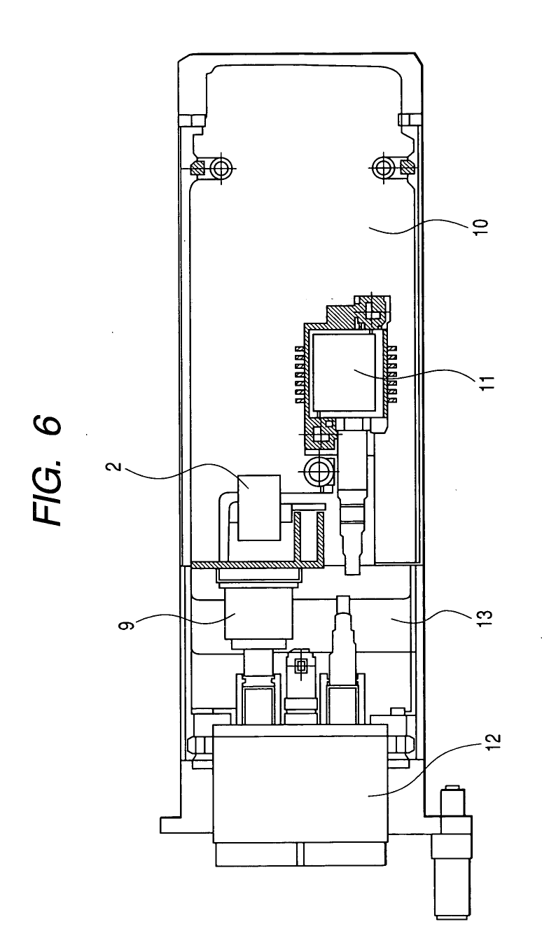

FIG. 6 shows a plan view of an optical module, and shows the structure of the optical module having a transmission speed of 10 Gbps using the connection structure of the flexible circuit and the connection process thereof according to the present invention as described in the first and second embodiments. The structure of the optical module according to this embodiment will be described roughly. A main portion of the optical module is made up of a printed circuit board 10 on which a laser diode module 11 is mounted, a photodiode 9 that is connected to an optical connector 12, and a flexible circuit 2 that is electrically connected between the connection terminals of the photodiode 9 and the printed circuit board 10. Those components are received in an aluminum case 13.

The relationships with symbols in the figure will be described in more detail. Reference numeral 2 denotes a flexible circuit, 9 is a PDM (photo diode module), 10 is a printed circuit board, 11 is an LDM (laser diode module), 12 is the optical connector, and 13 is the aluminum case that is about 120×35 mm in size.

The PDM 9, the printed circuit board 10, the LDM 11 and the optical connector 12 are fixed to the aluminum case 13. The PDM 9 and the printed circuit board 10 are electrically connected to each other by the flexible circuit 2, and the LDM 11 and the PDM 9 transmit and receive an optical signal through the optical connector 12, respectively.

Conventionally, in the case where the structural components such as the PDM 9 and the printed circuit board 10 are electrically connected to each other, a metal lead brazed to the PDM and the printed circuit board are connected with solder.

However, because downsizing and high reliability of the optical module in recent years make the metal lead and the connection area narrow, a stress is concentrated to the solder connection portion. For that reason, it becomes difficult to ensure the reliability for a long time, and disconnection may occur in the worst case. Under the circumstances, it is possible to provide the optical module that satisfies securing of both the high-frequency propagation characteristic and the long-time reliability by using the flexible circuit 2 and the connection process of the present invention for the electric connection of the PDM 9 and the printed circuit board 10.

The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

1. A connection structure of a rigid printed circuit board and a flexible circuit, comprising:
a rigid printed circuit board having a plurality of first connection terminals arranged at given intervals;
a flexible circuit having a plurality of second connection terminals that are connected to the corresponding first connection terminals at an end of a conductive pattern, a main portion of the conductive patterns being put by flexible to insulating resin while at least areas required for soldering of one surfaces of the second connection terminals are exposed;
a solder layer that electrically connects the first connection terminals and the second connection terminals; and
an insulated support material having a band shape with a given width for regulating a height of the solder connection, the insulated support material being disposed on an end area of the flexible insulating resin which is adjacent to the second connection terminals on the flexible circuit and faces the rigid printed circuit board.

2. The connection structure of a rigid printed circuit board and a flexible circuit according to claim 1, wherein when it is assumed that the thickness of the insulated support material is t₁, the thickness of the flexible insulating resin that interposes the conductive pattern of the flexible circuit therebetween which faces the rigid printed circuit board is t₂; and the thickness of the solder that is formed on the first connection terminals or the second connection terminals is t₀, the relationship of those thicknesses satisfies t₁+t₂≧t₀.

3. A connection process of a rigid printed circuit board and a flexible circuit, comprising the steps of:
preparing a rigid printed circuit board having a plurality of first connection terminals arranged at given intervals;
preparing a flexible circuit having a plurality of second connection terminals that are connected to the corresponding first connection terminals at an end of a conductive pattern, a main portion of the conductive patterns being put by flexible insulating resin while at least areas required for soldering of one surfaces of the second connection terminals are exposed;
forming a solder layer on at least one of the first connection terminals and the second connection terminals; and
positioning the first connection terminals and the second connection terminals with respect to each other and thermally compressing the first connection terminals and the second connection terminals together in a heated state at least at a solder melting temperature or higher,
wherein the step of preparing the flexible circuit comprises a step of forming an insulated support material having a band shape with a given width for regulating a height of the solder connection, on an end area of the flexible insulating resin which is adjacent to the second connection terminals on the flexible circuit and faces the rigid printed circuit board.

4. The connection process of a rigid printed circuit board and a flexible circuit according to claim 3, wherein when it is assumed that the thickness of the insulated support material is t₁, the thickness of the flexible insulating resin that interposes the conductive pattern of the flexible circuit therebetween which faces the rigid printed circuit board is t₂, and the thickness of the solder that is formed on the first connection terminals or the second connection terminals is t₀, the relationship of those thicknesses satisfies t₁+t₂≧tₒ.

5. The connection process of a rigid printed circuit board and a flexible circuit according to claim 3, wherein the step of forming the solder layer is conducted in a plating step in which a thickness t₀ of solder plating is set to 20 to 40 μm, and the connection terminals are connected to each other with the solder plating formed by controlling an amount of occlusion gas in the solder plating which is belched at the time of melting the solder.

6. The connection process of a rigid printed circuit board and a flexible circuit according to claim 3, wherein in the step of positioning the first connection terminals and the second connection terminals with respect to each other and thermally compressing the first connection terminals and the second connection terminals together in a heated state at least at a solder melting temperature or higher, the solder is melted and joined while the solder layer formed on the connection terminals under a pressure that does not crush the support material is pressurized and heated.

7. A connection structure of a rigid printed circuit board and a flexible circuit, comprising:
a rigid printed circuit board having a plurality of first connection terminals arranged at given intervals;
a flexible circuit having a plurality of second connection terminals that are connected to the corresponding first connection terminals at an end of a conductive pattern, a main portion of the conductive patterns being put by flexible insulating resin while at least areas required for soldering of one surfaces of the second connection terminals are exposed;
a solder layer that electrically connects the first connection terminals and the second connection terminals; and
an insulated support material for regulating a height of the solder connection, which is disposed between at least the second connection terminals on the flexible circuit that faces the first connection terminal surface of the rigid printed circuit board.

8. The connection structure of a rigid printed circuit board and a flexible circuit according to claim 7, wherein when it is assumed that the thickness of the insulated support material is t₁, the thickness of the flexible insulating resin that interposes the conductive pattern of the flexible circuit therebetween which faces the rigid printed circuit board is t₂, the thickness of the solder that is formed on the first connection terminals or the second connection terminals is t₀, and the thickness of the first connection terminal is t₃, the relationship of those thicknesses satisfies t₁+t₂+t₃≧t₀.

9. A connection process of a rigid printed circuit board and a flexible circuit, comprising the steps of:
preparing a rigid printed circuit board having a plurality of first connection terminals arranged at given intervals;
preparing a flexible circuit having a plurality of second connection terminals that are connected to the corresponding first connection terminals at an end of a conductive pattern, a main portion of the conductive patterns being put by flexible insulating resin while at least areas required for soldering of one surfaces of the second connection terminals are exposed;
forming a solder layer on at least one of the first connection terminals and the second connection terminals; and
positioning the first connection terminals and the second connection terminals with respect to each other and thermally compressing the first connection terminals and the second connection terminals together in a heated state at least at a solder melting temperature or higher,
wherein the step of preparing the flexible circuit comprises a step of forming an insulated support material for regulating a height of the solder connection between the adjacent second connection terminals.

10. The connection process of connecting a rigid printed circuit board and a flexible circuit according to claim 9, wherein when it is assumed that the thickness of the insulated support material is t₁, the thickness of the flexible insulating resin that interposes the conductive pattern of the flexible circuit therebetween which faces the rigid printed circuit board is t₂, the thickness of the solder that is formed on the first connection terminals or the second connection terminals is t₀, and the thickness of the first connection terminal is t₃, the relationship of those thicknesses satisfies t₁+t₂+t₃≧t₀.

11. The connection process of a rigid printed circuit board and a flexible circuit according to claim 9, wherein the step of forming the solder layer is conducted in a plating step in which a thickness t₀ of solder plating is set to 20 to 40 μm, and the connection terminals are connected to each other with the solder plating formed by controlling an amount of occlusion gas in the solder plating which is belched at the time of melting the solder.

12. The connection process of a rigid printed circuit board and a flexible circuit according to claim 9, wherein in the step of positioning the first connection terminals and the second connection terminals with respect to each other and thermally compressing the first connection terminals and the second connection terminals together in a heated state at least at a solder melting temperature or higher, the solder is melted and joined while the solder layer formed on the connection terminals under a pressure that does not crush the support material is pressurized and heated.

13. An optical module having a connection structure of a rigid printed circuit board and a flexible circuit, wherein the connection structure is constituted by a connection structure according to claim 1.

14. An optical module having a connection structure of a rigid printed circuit board and a flexible circuit, wherein the connection structure is constituted by a connection structure according to claim 2.

15. An optical module having a connection structure of a rigid printed circuit board and a flexible circuit, wherein the connection structure is constituted by a connection structure according to claim 7.

16. An optical module having a connection structure of a rigid printed circuit board and a flexible circuit, wherein the connection structure is constituted by a connection structure according to claim 8.
